(19) United States
(12) Patent Application Publication
(10) Pub. No.: US 2026/0052069 A1
(43) Pub. Date: Feb. 19, 2026

(54) SYSTEMS AND METHODS FOR NETWORK MANAGEMENT WITH LAYERED FULL-MESH NODE INTERCONNECTIONS

(71) Applicant: Samsung Electronics Co., Ltd., Suwon-si (KR)

(72) Inventors: Byung Choi, Fremont, CA (US); Changho Choi, San Jose, CA (US)

(21) Appl. No.: 18/958,261

(22) Filed: Nov. 25, 2024

Related U.S. Application Data
(60) Provisional application No. 63/684,713, filed on Aug. 19, 2024.

(51) Int. Cl. H04L 41/12

(52) U.S. Cl. CPC H04L 41/12

(57) ABSTRACT

Provided are systems and methods for network management. A system includes a switch baseboard including switches to interconnect nodes via a first layer connecting a first cluster of the nodes into full-mesh-connected nodes, a second cluster of the nodes into full-mesh-connected nodes, a third cluster of the nodes into full-mesh-connected nodes, and a fourth cluster of the nodes into full-mesh-connected nodes, and a second layer including inter-cluster connections to connect a first node of the first cluster to a first node of the second cluster by one hop, and a first node of the third cluster by one hop.

### CROSS-REFERENCE TO RELATED APPLICATION(S)

This application claims priority to, and benefit of, U.S. Provisional Application Ser. No. 63/684,713, filed on Aug. 19, 2024, entitled “MEMORY SWITCH MODULE & BASEBOARD ARCHITECTURE SUPPORT MULTI-BANDWIDTH (BW) LINKS FOR A SYSTEM UTILIZING A CACHE-COHERENCY BASED PROTOCOL WITH MEMORY, COMPUTE AND/OR CACHE MANAGEMENT COMPONENTS,” the entire content of which is incorporated herein by reference.

### FIELD

Aspects of some embodiments of the present disclosure relate to systems and methods for network management.

### BACKGROUND

In the field of computers, a computing system may include one or more hosts and one or more memory devices connected to (e.g., communicatively coupled to) the one or more hosts. Such computing systems have become increasingly popular, in part, for allowing many different users to share the computing resources of the system. Memory requirements have increased over time as the number of users of such systems and the number and complexity of applications running on such systems have increased.

The present background section is intended to provide context only, and the disclosure of any embodiment or concept in this section does not constitute an admission that said embodiment or concept is prior art.

### SUMMARY

Aspects of some embodiments of the present disclosure are directed to computing systems for improved network management.

According to some embodiments of the present disclosure, there is provided a system for network management, the system including a switch baseboard including switches to interconnect nodes via a first layer connecting a first cluster of the nodes into full-mesh-connected nodes, a second cluster of the nodes into full-mesh-connected nodes, a third cluster of the nodes into full-mesh-connected nodes, and a fourth cluster of the nodes into full-mesh-connected nodes, and a second layer including inter-cluster connections to connect a first node of the first cluster to a first node of the second cluster by one hop, and a first node of the third cluster by one hop.

The switches may include a first switch including a first set of ports associated with the first layer, and a second set of ports associated with the second layer.

The first set of ports may be associated with a first bandwidth that is different from a second bandwidth associated with the second set of ports.

The second layer may further include inter-cluster connections to connect the first node of the first cluster to a first node of the fourth cluster by one hop.

The second layer may further include inter-cluster connections to connect a second node of the first cluster to a second node of the second cluster by one hop, a second node of the third cluster by one hop, and a second node of the fourth cluster by one hop, and a third node of the first cluster to a third node of the second cluster by one hop, a third node of the third cluster by one hop, and a third node of the fourth cluster by one hop, and a fourth node of the first cluster to a fourth node of the second cluster by one hop, a fourth node of the third cluster by one hop, and a fourth node of the fourth cluster by one hop.

The first layer may include a first port having a first bandwidth, the second layer may include a second port having a second bandwidth, and the second bandwidth may be greater than the first bandwidth.

The first layer may include a third port having a third bandwidth that is less than the second bandwidth, the first port may be configured to send a first signal to a bundling-circuit, the third port may be configured to send a second signal to the bundling-circuit, and an output of the bundling-circuit may be connected to the second port.

The inter-cluster connections may form hyper-torus connections between the nodes.

The nodes may include memory and may be interconnected to form a memory pool.

The switch baseboard may be configured to support a cache-coherent protocol.

The switch baseboard may be a first switch baseboard of n switch baseboards of the system, n being an integer greater than one, and the n switch baseboards may support 16×n nodes.

According to some other embodiments of the present disclosure, there is provided a method for network management, the method including receiving, by a switch baseboard, data from a first node of a set of nodes connected to the switch baseboard, and sending, by the switch baseboard, the data to a second node of the set of nodes, the first node and the second node being separated by two hops, wherein the switch baseboard, includes switches to interconnect the nodes of the set of nodes via a first layer connecting a first cluster of nodes of the set of nodes into full-mesh-connected nodes including the first node as the first node of the first cluster, a second cluster of nodes of the set of nodes into full-mesh-connected nodes, a third cluster of nodes of the set of nodes into full-mesh-connected nodes including the second node as a second node of the third cluster, and a fourth cluster of nodes of the set of nodes into full-mesh-connected nodes, and a second layer including inter-cluster connections to connect the first node of the first cluster to a first node of the third cluster by one hop, the first node of the third cluster being connected to the second node of the third cluster by one hop.

The second layer may further include inter-cluster connections to connect the first node of the first cluster to a first node of the second cluster by one hop, and a first node of the fourth cluster by one hop.

The switches may include a first switch including a first set of ports associated with the first layer, and a second set of ports associated with the second layer.

The first set of ports may be associated with a first bandwidth that may be different from a second bandwidth associated with the second set of ports.

The second layer may further include inter-cluster connections to connect the second node of the third cluster to a second node of the fourth cluster by one hop.

The nodes of the set of nodes may include memory and may be interconnected to form a memory pool.

The switch baseboard may be configured to support a cache-coherent protocol.

The switch baseboard may be a first switch baseboard of n switch baseboards of a system, n being an integer greater than one, and the n switch baseboards may support 16×n nodes.

According to some other embodiments of the present disclosure, there is provided a system for network management, the system including a switch baseboard including switches to interconnect nodes via a first layer connecting a first cluster of the nodes into full-mesh-connected nodes, a second cluster of the nodes into full-mesh-connected nodes, and a third cluster of the nodes into full-mesh-connected nodes, and a second layer including inter-cluster connections to connect a first node of the first cluster to a first node of the second cluster by one hop, and a first node of the third cluster by one hop, wherein the switch baseboard is configured to receive data from a first node of the nodes, and send the data to a second node of the nodes, the first node and the second node being separated by two hops.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram depicting a system for network management, according to some embodiments of the present disclosure.

FIG. 2A is a diagram depicting a four-node clustering architecture for one cluster of four full-mesh-connected nodes, according to some embodiments of the present disclosure.

FIG. 2B is a block diagram depicting a node clustering architecture (e.g., a four-node clustering architecture) using switches (e.g., six switches) to connect nodes (e.g., four nodes) into the one cluster of full-mesh-connected nodes (e.g., four full-mesh-connected nodes) of FIG. 2A, based on port connections (e.g., six port connections) at each node, according to some embodiments of the present disclosure.

FIG. 2C is a block diagram depicting a node clustering architecture (e.g., a four-node clustering architecture) using switches (e.g., six switches) to connect nodes (e.g., four nodes) into the one cluster of full-mesh-connected nodes (e.g., four full-mesh-connected nodes) of FIG. 2A, based on port connections (e.g., three port connections) at each node, according to some embodiments of the present disclosure.

FIG. 3A is a diagram depicting a first layer of full-mesh interconnections forming clusters (e.g., four clusters) of full-mesh-connected nodes (e.g., four full-mesh-connected nodes), according to some embodiments of the present disclosure.

FIG. 3B is a diagram depicting a first portion of the second layer of full-mesh interconnections forming inter-cluster connections with respect to a first node of the first cluster of FIG. 3A, according to some embodiments of the present disclosure.

FIG. 3C is diagram depicting a second portion of the second layer of full-mesh interconnections forming inter-cluster connections from a second node of the first cluster of FIG. 3A, according to some embodiments of the present disclosure.

FIG. 3D is a diagram depicting a third portion of the second layer of full-mesh interconnections forming inter-cluster connections from a third node of the first cluster of FIG. 3A, according to some embodiments of the present disclosure.

FIG. 3E is a diagram depicting a fourth portion of the second layer of full-mesh interconnections forming inter-cluster connections from a fourth node of the first cluster of FIG. 3A, according to some embodiments of the present disclosure.

FIGS. 4A-4F are diagrams depicting the connections of the system, which are also shown in FIG. 1, with respect to each of the switches, individually, according to some embodiments of the present disclosure.

FIG. 4A is a block diagram depicting connections of the first layer and the second layer associated with a first switch, according to some embodiments of the present disclosure.

FIG. 4B is a block diagram depicting connections of the first layer and the second layer associated with a second switch, according to some embodiments of the present disclosure.

FIG. 4C is a block diagram depicting connections of the first layer and the second layer associated with a third switch, according to some embodiments of the present disclosure.

FIG. 4D is a block diagram depicting connections of the first layer and the second layer associated with a fourth switch, according to some embodiments of the present disclosure.

FIG. 4E is a block diagram depicting connections of the first layer and the second layer associated with a fifth switch, according to some embodiments of the present disclosure.

FIG. 4F is a block diagram depicting connections of the first layer and the second layer associated with a sixth switch, according to some embodiments of the present disclosure.

FIG. 5A is a diagram depicting potential data paths within a switch corresponding to one or more of the switches of the system for network management, the switch having single bandwidth ports, according to some embodiments of the present disclosure.

FIG. 5B is a diagram depicting potential data paths within a switch corresponding to one or more of the switches of the system for network management, the switch having multi-bandwidth ports, according to some embodiments of the present disclosure.

FIG. 5C is a diagram depicting an example of how the link-bundling circuit of the switch of FIG. 5B may be configured for connecting multi-bandwidth ports, according to some embodiments of the present disclosure.

FIG. 6A is a flowchart depicting operations of a method for network management using the switch of FIG. 5A or FIG. 5B, according to some embodiments of the present disclosure.

FIG. 6B is a flowchart depicting operations of a method for network management using the switch of FIG. 5B and the switch of FIG. 50, according to some embodiments of the present disclosure.

FIG. 7 is a flowchart depicting operations of a method for network management, including sending data from one node to another node, according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Any of the functionalities described herein, including any of the functionalities that may be implemented with a host, a device, and/or the like or a combination thereof, may be implemented with hardware, software, firmware, or any combination thereof including, for example, hardware and/or software combinational logic, sequential logic, timers, counters, registers, state machines, volatile memories such as dynamic RAM (DRAM) and/or static

RAM (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application-specific ICs (ASICs), central processing units (CPUs) including complex instruction set computer (CISC) processors and/or reduced instruction set computer (RISC) processors, graphics processing units (GPUs), neural processing units (NPUs), tensor processing units (TPUs), data processing units (DPUs), and/or the like, executing instructions stored in any type of memory. In some embodiments, one or more components may be implemented as a system-on-a-chip (SoC).

Any of the computational devices disclosed herein may be implemented in any form factor, such as 3.5 inch, 2.5 inch, 1.8 inch, M.2, Enterprise and Data Center Standard Form Factor (EDSFF), NF1, and/or the like, using any connector configuration such as Serial Advanced Technology Attachment (SATA), Small Computer System Interface (SCSI), Serial Attached SCSI (SAS), U.2, and/or the like. Any of the computational devices disclosed herein may be implemented entirely or partially with, and/or used in connection with, a server chassis, server rack, data room, data center, edge data center, mobile edge data center, and/or any combinations thereof.

Any of the devices disclosed herein that may be implemented as storage devices may be implemented with any type of nonvolatile storage media based on solid-state media, magnetic media, optical media, and/or the like. For example, in some embodiments, a storage device (e.g., a computational storage device) may be implemented as an SSD based on not-AND (NAND) flash memory, persistent memory such as cross-gridded nonvolatile memory, memory with bulk resistance change, PCM, and/or the like, or any combination thereof.

Any of the communication connections and/or communication interfaces disclosed herein may be implemented with one or more interconnects, one or more networks, a network of networks (e.g., the Internet), and/or the like, or a combination thereof, using any type of interface and/or protocol. Examples include Peripheral Component Interconnect Express (PCIe), non-volatile memory express (NVMe), NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, SATA, SCSI, SAS, Internet Wide Area RDMA Protocol (iWARP), and/or a coherent protocol, such as Compute Express Link (CXL), CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced extensible Interface (AXI), any generation of wireless network including 2G, 3G, 4G, 5G, 6G, and/or the like, any generation of Wi-Fi, Bluetooth, near-field communication (NFC), and/or the like, or any combination thereof.

In some embodiments, a software stack may include a communication layer that may implement one or more communication interfaces, protocols, and/or the like such as PCIe, NVMe, CXL, Ethernet, NVMe-oF, TCP/IP, and/or the like, to enable a host and/or an application running on the host to communicate with a computational device or a storage device.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of computers, a computing system may include one or more hosts and one or more memory devices connected to (e.g., communicatively coupled to) the one or more hosts. For example, a data center may perform network management to provide computing resources of one or more hosts and/or one or more memory devices to users. The computing resources may be provided based on a plurality of interconnected nodes in the computing system. For example, each node may include a memory (e.g., DRAM) and/or storage (e.g., NAND) and the nodes may be interconnected via a switchboard to create one or more memory pools. A memory pool may be created based on a basic building block of nodes for memory clustering. The basic building block of nodes may allow for scaling of memory as demand for memory increases. For example, Artificial Intelligence (AI) applications may rely on large amounts of memory and/or may utilize memory with specific performance characteristics. For example, to approach capabilities of the human brain, some computing systems for AI may perform Exascale computing, involving about 10\hat{ }18 math operations per second, may consume and/or dissipate significant power, may use significant memory (e.g., 2.5 petabytes (PB) or 2.5×10\hat{ }15 bytes), may perform operations with significant amounts of parameters (e.g., 100 trillions of parameters).

Although the present disclosure is focused largely on nodes for creating memory pools. It should be understood that the present application is not limited thereto, and one of ordinary skill in the art would understand that aspects of some embodiments of the present disclosure may be applied to a variety of network node interconnections. For example, aspects of some embodiments of the present disclosure may be applied to perform clustering of a variety of node types (e.g., CPU and/or GPU cluster, artificial intelligence processing unit (AIPU) clustering, and the like).

Modern technologies, such as CXL and the like, allow for the ability to create large memory pools in suitable ways. For example, memory pools may be created with manageable (e.g., customizable) features, such as lower bandwidth and/or higher bandwidth capabilities and/or customizable latency (LT) capabilities.

Aspects of some embodiments of the present disclosure provide for improvements to the basic building blocks for resource pools (e.g., for memory pools). In some computing systems, a basic building block for resource pooling may be based on eight nodes. As discussed in further detail below, in some embodiments of the present disclosure, resource pooling may be expanded to be based on more than eight nodes (e.g., 16 nodes) as a basic building block, with lower latencies and improved bandwidth handling for the same conditions (e.g., for the same number of nodes per cluster).

In some embodiments, a switch baseboard may be formed by switches (e.g., six switch modules) to interconnect (e.g., to link) the nodes (e.g., the 16 nodes). The switch baseboard may be used as a building block resource pooling (e.g., for memory pooling). In some embodiments, the switch baseboard may support operations of a cache-coherent protocol (e.g., CXL and/or the like) for sending and receiving data between the nodes (e.g., the 16 nodes).

Aspects of some embodiments of the present disclosure allow for resource pooling that may be scaled in a simple and efficient manner based on applying the same rule to interconnect any suitable multiple of a set of nodes (e.g., a set of 16 nodes or any suitable multiple of 4 nodes).

Aspects of some embodiments of the present disclosure may allow for latency manageable resource pooling. For example, resource pools may be provided based on a controllable hop count between nodes. As used herein, a “hop” refers to a connection between two nodes that does not include intervening nodes. As used herein, a “hop count” refers to a number of hops between two nodes. For example, if node A is separated from node C by only one node (e.g., node B), then the hop count from node A to node C would be two (e.g., one hop from node A to node B and one hop from node B to node C).

Aspects of some embodiments of the present disclosure provide for a modular, scalable, and composable memory-switch architecture.

In some embodiments, full-mesh connections may be utilized for least-latency management. As used herein, “full-mesh” or “full-mesh-connected” refers to a grouping of nodes (e.g., a cluster of nodes or more than one interconnected clusters) that are connected to each other by one hop. Aspects of some embodiments of the present disclosure allow for tiered memory (TM) services to be provided based on memory pools constructed with multiple latencies. For example, a cloud service provider (CSP) may be enabled to create memory class services (e.g., good, better, and best classes) by performing resource pooling with aspects of some embodiments of the present disclosure. For example, nodes associated with fewer hops may be provided for better and best classes.

In some embodiments, full-mesh connections may be provided by switches (e.g., by switch modules). For example, switches (e.g., six switches) may be utilized to provide full-mesh connections for clusters of nodes (e.g., four nodes). In some embodiments, the switches (e.g., six switches) may also provide inter-cluster connections between each of the nodes (e.g., four nodes) in one cluster with corresponding nodes of a second cluster. For example, the inter-cluster connections may form hyper-torus connections between the nodes (e.g., sixteen nodes). The full-mesh connections for clusters (e.g., within clusters) of nodes (e.g., four nodes) may correspond to a first layer (also referred to as a first dimension) of connections. The inter-cluster connections may correspond to a second layer (also referred to as a second dimension) of connections. In some embodiments, the first layer of connections may provide lower bandwidth links (e.g., lower bandwidth paths) between nodes than the second layer of connections. In some embodiments, some ports of the first layer, associated with a lower bandwidth, may be bundled with (e.g., multiplexed with) other ports of the first layer and may be sent to a port of the second layer that is associated with a higher bandwidth.

Aspects of some embodiments of the present disclosure may allow for limitless network growth (e.g., limitless scaling), as long as the corresponding latencies are allowed for a given tiered memory (e.g., a tiered memory associated with AI workloads and/or high-performance computing (HPC) workloads).

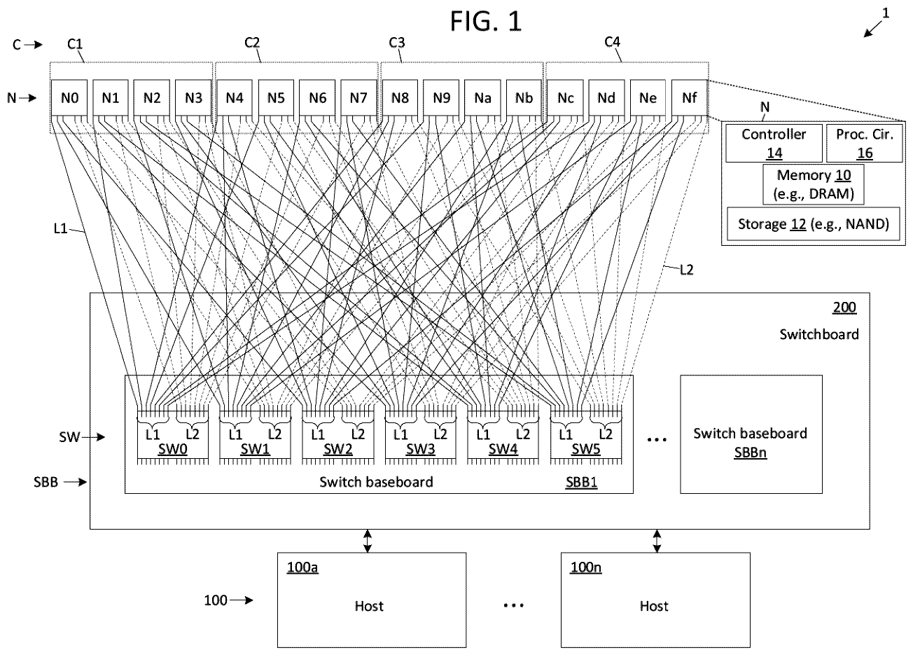

FIG. 1 is a block diagram depicting a system 1 for network management, according to some embodiments of the present disclosure.

Referring to FIG. 1, the system 1 may include a switchboard 200 comprising one or more switch baseboards SBB (e.g., a first switch baseboard SBB1 through an n-th switch baseboard SBBn, where n is an integer greater than 1). Each switch baseboard SBB may include one or more switches SW (e.g., a switch SW0 through a switch SW5). The switches SW may be connected to (e.g., connected with) corresponding ones of nodes N. The switches SW may provide interconnections between the nodes N.

In some embodiments, the switches SW of one switch baseboard SBB may connect the nodes N into clusters C. As used herein, connecting a plurality of nodes “into” a cluster means adding connections to (e.g., between) the nodes so that the nodes and the connections form the cluster. For example, the switches SW may provide connection paths (e.g., paths for transferring data) between corresponding ones of the nodes N, such that the nodes N are connected to each other through the switches SW into clusters C. In some embodiments, switches SW (e.g., six switches SW, including the switch SW0 through the switch SW5) may be used to connect a set of nodes N (e.g., a set of 16 nodes N, including a node N0 through a node Nf) into clusters C of a given number of nodes N per cluster (e.g., four clusters C, including a cluster C1 though a cluster C4 of four nodes N per cluster C). For example, the first cluster C1 may include the node N0 (e.g., a first node of the 16 nodes), a node N1, a node N2, and a node N3. A second cluster C2 may include a node N4, a node N5, a node N6, and a node N7. A third cluster C3 may include a node N8, a node N9, and a node Na (e.g., an 11th node of the 16 nodes), and a node Nb (e.g., a 12th node of the 16 nodes). The fourth cluster C4 may include a node Nc (e.g., a 13th node of the 16 nodes), a node Nd (e.g., a 14th node of the 16 nodes), a node Ne (e.g., a 15th node of the 16 nodes), and a node Nf (e.g., a 16th node of the 16 nodes).

In some embodiments, and as discussed in further detail below, each switch SW may provide (e.g., contribute to providing) connections associated with a first layer L1 (e.g., a first layer of connections, also referred to as a first dimension of connections) and connections associated with a second layer L2 (e.g., a second layer of connections, also referred to as a second dimension of connections). For example, the solid lines connected between the switches SW and the nodes N in FIG. 1 depict connection paths (e.g., links) of the first layer L1 and the dashed lines connected between the switches SW and the nodes N in FIG. 1 depict connection paths (e.g., links) of the second layer L2. The first layer L1 and the second layer L2 may provide the physical layer of connections between the nodes N of the system 1.

In some embodiments, each of the nodes N may include a memory 10 (e.g., DRAM). For example, the nodes N may be memory nodes that are interconnected to form one or more memory pools. In some embodiments, each of the nodes N may include a storage 12 (e.g., NAND). For example, the nodes N may be storage devices that are interconnected to provide storage capabilities and/or memory capabilities. In some embodiments, the nodes N may include a controller 14 and/or a processing circuit 16 (e.g., an FPGA, an ASIC, and/or the like). In some embodiments, the nodes N may include an AIPU, a GPU, and/or a CPU.

In some embodiments, each switch baseboard SBB may provide interconnections for nodes N (e.g., 16 nodes N) as a basic building block for resource pooling. For example, using n switch baseboards SBB may allow the system 1 to support 16×n (e.g., 16 multiplied by n) nodes N, where n is an integer greater than 1. For example, using four switch baseboards SBB (e.g., n=4) may allow the system 1 to support 64 nodes. As discussed in further detail below, the switches SW may interconnect the nodes N (e.g., the 16 nodes N) via the first layer L1 and via the second layer L2, such that the greatest number of hops between any two nodes N of the nodes N (e.g., the 16 nodes N) is two hops. In some embodiments, one or more switch baseboards SSB may be connected by one hop, such that the greatest number of hops between any two nodes N in separate switch baseboards SSB may be three hops.

In some embodiments, the switchboard 200 may be communicatively coupled to one or more hosts 100 (e.g., a first host 100a through an n-th host 100n). For example, each of the hosts 100 may include one or more XPUs (e.g., where an XPU includes a CPU, a GPU, an APU, an NPU, an FPGA, and/or the like) to send and/or receive data to and/or from the nodes N. In some embodiments, the switch baseboards SBB may support a cache-coherent protocol for transferring data between the hosts 100 and/or the nodes N. For example, the cache-coherent protocol may include a CXL protocol.

As discussed in further detail below, the switch SW0 may provide connections between nodes N0 N1, N4, N5, N8, N9, Nc, and Nd from each of the clusters C (e.g., the four clusters C), via the first layer L1. The switch SW0 may provide connections (e.g., inter-cluster connections) between each of the nodes N of the clusters C1 and C2, via the second layer L2.

The switch SW1 may provide connections between nodes N0 N2, N4, N6, N8, Na, Nc, and Ne from each of the clusters C (e.g., the four clusters C), via the first layer L1. The switch SW1 may provide connections (e.g., inter-cluster connections) between each of the nodes N of the clusters C1 and C3, via the second layer L2.

The switch SW2 may provide connections between nodes N0 N3, N4, N7, N8, Nb, Nc, and Nf from each of the clusters C (e.g., the four clusters C), via the first layer L1. The switch SW2 may provide connections (e.g., inter-cluster connections) between each of the nodes N of the clusters C1 and C4, via the second layer L2.

The switch SW3 may provide connections between nodes N1, N3, N5, N7, N9, Nb, Nd, and Nf from each of the clusters C (e.g., the four clusters C), via the first layer L1. The switch SW3 may provide connections (e.g., inter-cluster connections) between each of the nodes N of the clusters C2 and C4, via the second layer L2.

The switch SW4 may provide connections between nodes N1, N2, N5, N6, N9, Na, Nd, and Ne from each of the clusters C (e.g., the four clusters C), via the first layer L1. The switch SW4 may provide connections (e.g., inter-cluster connections) between each of the nodes N of the clusters C2 and C3, via the second layer L2.

The switch SW5 may provide connections between nodes N2, N3, N6, N7, Na, Nb, Ne, and Nf from each of the clusters C (e.g., the four clusters C), via the first layer L1. The switch SW5 may provide connections (e.g., inter-cluster connections) between each of the nodes N of the clusters C3 and C4, via the second layer L2.

Although specific numbers of components (e.g., nodes N, switches SW, clusters C, and ports P) and connections to the components are disclosed herein, it should be understood that the present disclosure is not limited to the specific numbers of components and connections thereto. For example, any suitable number of nodes may be connected (e.g., interconnected) into any suitable number of clusters of full-mesh-connected nodes according to aspects of some embodiments of the present disclosure.

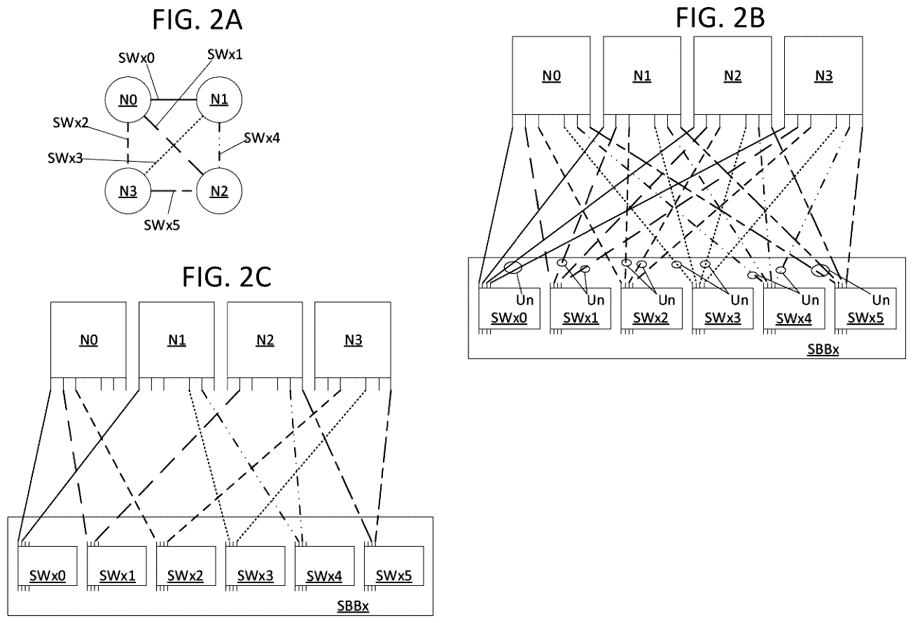

FIG. 2A is a diagram depicting a node clustering architecture (e.g., a four-node clustering architecture) for one cluster of full-mesh-connected nodes N (e.g., four full-mesh-connected nodes N), according to some embodiments of the present disclosure.

Referring to FIG. 2A, in some embodiments, switches may be used to connect nodes into clusters of full-mesh-connected nodes, meaning that each node of the cluster is connected to each other node of the cluster by one hop. For example, nodes (e.g., four nodes) may be interconnected as full-mesh-connected nodes (e.g., four full-mesh-connected nodes) using switches (e.g., six switches). For example, a switch SWx0 may connect node N0 with node N1 by one hop; a switch SWx1 may connect node N0 with node N2 by one hop; a switch SWx2 may connect node N0 with node N3 by one hop; a switch SWx3 may connect node N1 with node N3 by one hop; a switch SWx4 may connect node N1 with node N2 by one hop; and a switch SWx5 may connect node N2 with node N3 by one hop.

FIG. 2B is a block diagram depicting a node clustering architecture (e.g., a four-node clustering architecture) using switches SW (e.g., six switches SW) to connect nodes N (e.g., four nodes N) into the one cluster of full-mesh-connected nodes N (e.g., four full-mesh-connected nodes N) of FIG. 2A, based on port connections (e.g., six port connections) at each node N, according to some embodiments of the present disclosure.

Referring to FIG. 2B, each of the switches SWx0 through SWx5 may be connected to corresponding ports on each of nodes N0 through N3. Each of the switches (e.g., switch modules) SWx0 through SWx5 may include link- (e.g., port-) configuration capabilities to designate (e.g., to configure) some of the links (e.g., connections) as unused Un. For example, switch SWx0 may have links to nodes N2 and N3 designated as unused Un; switch SWx1 may have links to nodes N1 and N3 designated as unused Un; switch SWx2 may have links to nodes N1 and N2 designated as unused Un; SWx3 may have links to nodes N0 and N2 designated as unused Un; SWx4 may have links to nodes N0 and N3 designated as unused Un; and SWx5 may have links to nodes N0 and N1 designated as unused Un.

FIG. 2C is a block diagram depicting a node clustering architecture (e.g., a four-node clustering architecture) using switches SW (e.g., six switches SW) to connect nodes N (e.g., four nodes N) into the one cluster of full-mesh-connected nodes N (e.g., four full-mesh-connected nodes N) of FIG. 2A, based on port connections (e.g., three port connections) at each node N, according to some embodiments of the present disclosure.

Referring to FIG. 2C each of the switches SWx0 through SWx5 may be connected to corresponding ports on each of nodes N0 through N3. For example, the switch SWx0 may interconnect nodes N0 and N1; the switch SWx1 may interconnect nodes N0 and N2; the switch SWx2 may interconnect nodes N0 and N3; the switch SWx2 may interconnect nodes N0 and N3; the switch SWx3 may interconnect nodes N1 and N3; the switch SWx4 may interconnect nodes N1 and N2; and the switch SWx5 may interconnect nodes N2 and N3.

It should be understood that each hop between any two given nodes N is related to latency. Thus, two nodes connected by one hop may be associated with a lower latency than two nodes connect by more than one hop, provided all other conditions are equal. Accordingly, a cluster of full-mesh-connected nodes may provide for lower latencies than a cluster of nodes that are not full-mesh-connected nodes.

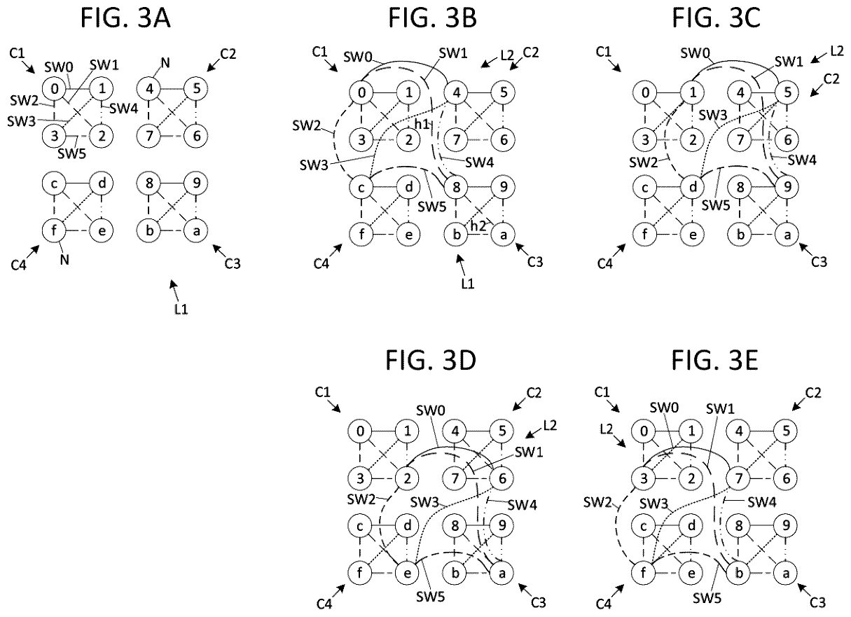

FIG. 3A is a diagram depicting a first layer of full-mesh interconnections forming clusters (e.g., four clusters (C1-C4)) of full-mesh-connected nodes N (e.g., four full-mesh-connected nodes N), according to some embodiments of the present disclosure.

Referring to FIG. 3A, the nodes N (e.g., the 16 nodes N, including nodes NO through Nf of FIG. 1) may be interconnected based on connecting the nodes N into clusters (e.g., four clusters) of full-mesh-connected nodes N (e.g., four full-mesh-connected nodes N), via the first layer L1.

For example, the switch SW0 may connect: nodes N0 and N1 (of cluster C1) together by one hop; nodes N4 and N5 (of cluster C2) together by one hop; nodes N8 and N9 (of cluster C3) together by one hop; and nodes Nc and Nd (of cluster C4) together by one hop. The switch SW1 may connect: nodes N0 and N2 (of cluster C1) together by one hop; nodes N4 and N6 (of cluster C2) together by one hop; nodes N8 and Na (of cluster C3) together by one hop; and nodes Nc and Ne (of cluster C4) together by one hop. The switch SW2 may connect: nodes N0 and N3 (of cluster C1) together by one hop; nodes N4 and N7 (of cluster C2) together by one hop; nodes N8 and Nb (of cluster C3) together by one hop; and nodes Nc and Nf (of cluster C4) together by one hop. The switch SW3 may connect: nodes N1 and N3 (of cluster C1) together by one hop; nodes N5 and N7 (of cluster C2) together by one hop; nodes N9 and Nb (of cluster C3) together by one hop; and nodes Nd and Nf (of cluster C4) together by one hop. The switch SW4 may connect: nodes N1 and N2 (of cluster C1) together by one hop; nodes N5 and N6 (of cluster C2) together by one hop; nodes N9 and Na (of cluster C3) together by one hop; and nodes Nd and Ne (of cluster C4) together by one hop. The switch SW5 may connect: nodes N2 and N3 (of cluster C1) together by one hop; nodes N6 and N7 (of cluster C2) together by one hop; nodes Na and Nb (of cluster C3) together by one hop; and nodes Ne and Nf (of cluster C4) together by one hop.

FIG. 3B is a diagram depicting a first portion of the second layer L2 of full-mesh interconnections forming inter-cluster connections with respect to the node N0 of the cluster C1 of FIG. 3A, according to some embodiments of the present disclosure.

Referring to FIG. 3B, each one of nodes N0 N4, N8, and Nc, which may be referred to as first nodes of each of the four clusters C1, C2, C3, and C4, may be interconnected by one hop.

For example, the switch SW0 may connect nodes N0 and N4 (of clusters C1 and C2) together by one hop; the switch SW1 may connect nodes N0 and N8 (of clusters C1 and C3) together by one hop; the switch SW2 may connect nodes N0 and Nc (of clusters C1 and C4) together by one hop; the switch SW3 may connect nodes N4 and Nc (of clusters C2 and C4) together by one hop; the switch SW4 may connect nodes N4 and N8 (of clusters C2 and C3) together by one hop; and the switch SW5 may connect nodes N8 and Nc (of clusters C3 and C4) together by one hop.

Based on the two layers of connections provided by the first layer L1 and the second layer L2, a worst-case hop-count scenario between any two nodes out of the 16 nodes N0 through Nf may be equal to two hops. For example, data sent from node N0 to node Na may be sent from node N0 to node N8 via switch SW1 (accounting for a first hop h1). The data may be sent from node N8 to node Na via switch SW1 (accounting for a second hop h2).

Some systems that interconnect eight nodes as a basic building block may have a worst-case hop-count scenario between any two nodes out of 16 nodes being equal to five hops based on connecting node N0 to node N4, node N1 to node N5, node N3 to node N7, and node N2 to node N6, and joining two of such sets together by one hop. Accordingly, aspects of some embodiments of the present disclosure allow for a reduction in hop count (e.g., in a worst-case hop-count scenario).

FIG. 3C is a diagram depicting a second portion of the second layer L2 of full-mesh interconnections forming inter-cluster connections from the node N1 of the cluster C1 of FIG. 3A, according to some embodiments of the present disclosure.

Referring to FIG. 3C, each one of nodes N1, N5, N9, and Nd, which may be referred to as second nodes of each of the four clusters C1, C2, C3, and C4, may be interconnected by one hop.

For example, the switch SW0 may connect nodes N1 and N5 (of clusters C1 and C2) together by one hop; the switch SW1 may connect nodes N1 and N9 (of clusters C1 and C3) together by one hop; the switch SW2 may connect nodes N1 and Nd (of clusters C1 and C4) together by one hop; the switch SW3 may connect nodes N5 and Nd (of clusters C2 and C4) together by one hop; the switch SW4 may connect nodes N5 and N9 (of clusters C2 and C3) together by one hop; and the switch SW5 may connect nodes N9 and Nd (of clusters C3 and C4) together by one hop.

FIG. 3D is a diagram depicting a third portion of the second layer L2 of full-mesh interconnections forming inter-cluster connections from the node N2 of the cluster C1 of FIG. 3A, according to some embodiments of the present disclosure.

Referring to FIG. 3D, each one of nodes N2, N6, Na, and Ne, which may be referred to as third nodes of each of the four clusters C1, C2, C3, and C4, may be interconnected by one hop.

For example, the switch SW0 may connect nodes N2 and N6 (of clusters C1 and C2) together by one hop; the switch SW1 may connect nodes N2 and Na (of clusters C1 and C3) together by one hop; the switch SW2 may connect nodes N2 and Ne (of clusters C1 and C4) together by one hop; the switch SW3 may connect nodes N6 and Ne (of clusters C2 and C4) together by one hop; the switch SW4 may connect nodes N6 and Na (of clusters C2 and C3) together by one hop; and the switch SW5 may connect nodes Na and Ne (of clusters C3 and C4) together by one hop.

FIG. 3E is a diagram depicting a fourth portion of the second layer L2 of full-mesh interconnections forming inter-cluster connections from the node N3 of the cluster C1 of FIG. 3A, according to some embodiments of the present disclosure.

Referring to FIG. 3D, each one of nodes N3, N7, Nb, and Nf, which may be referred to as fourth nodes of each of the four clusters C1, C2, C3, and C4, may be interconnected by one hop.

For example, the switch SW0 may connect nodes N3 and N7 (of clusters C1 and C2) together by one hop; the switch SW1 may connect nodes N3 and Nb (of clusters C1 and C3) together by one hop; the switch SW2 may connect nodes N3 and Nf (of clusters C1 and C4) together by one hop; the switch SW3 may connect nodes N7 and Nf (of clusters C2 and C4) together by one hop; the switch SW4 may connect nodes N7 and Nb (of clusters C2 and C3) together by one hop; and the switch SW5 may connect nodes Nb and Nf (of clusters C3 and C4) together by one hop.

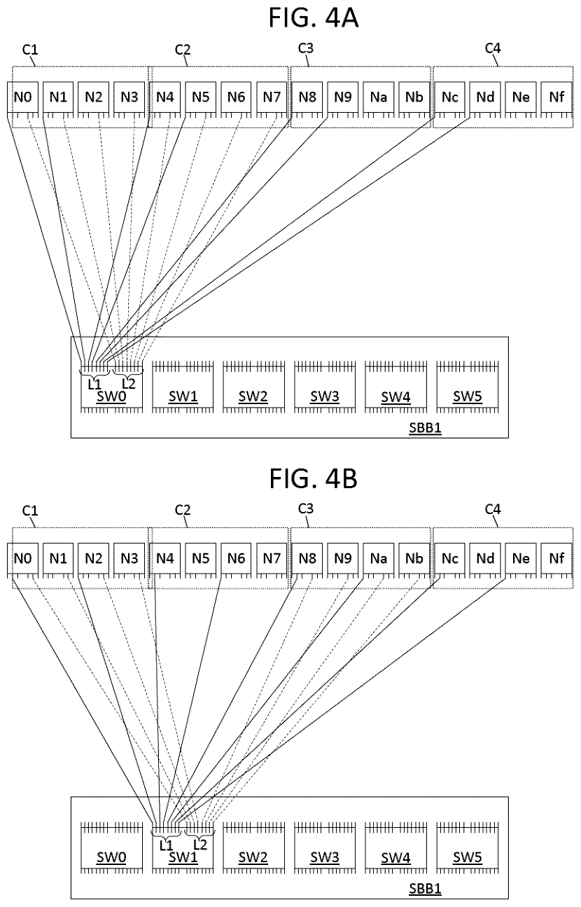

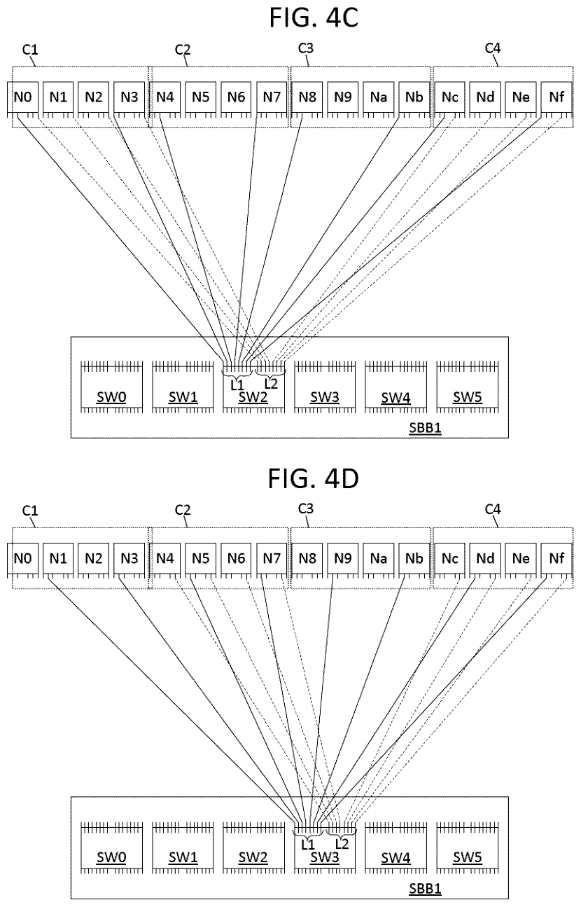

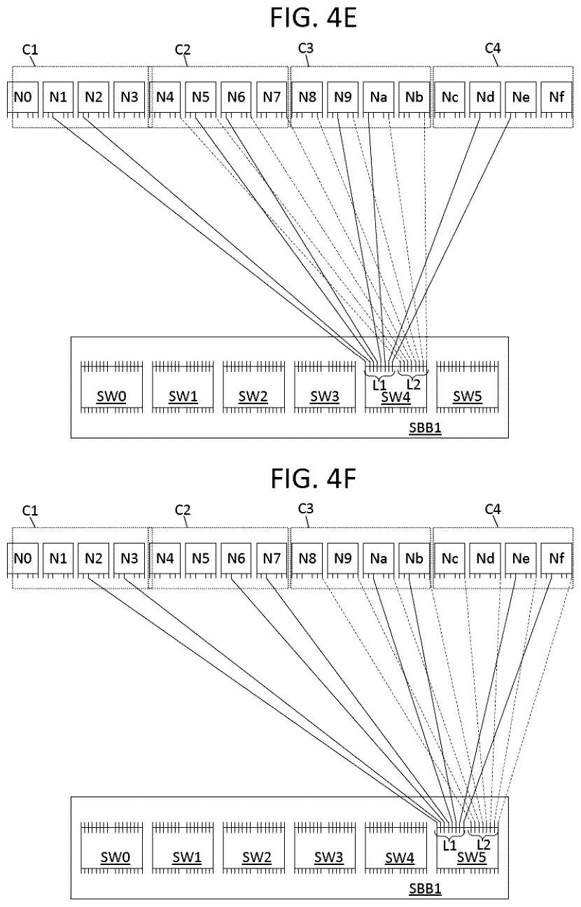

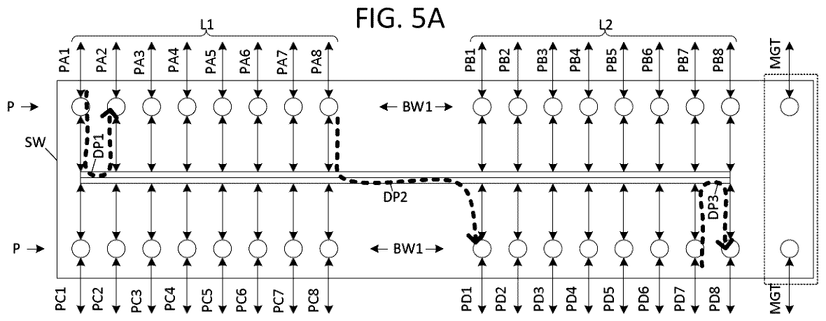

FIGS. 4A to 4F are diagrams depicting the connections of the system 1, which are also shown in FIG. 1, with respect to each of the switches SW0 to SW5, individually, according to some embodiments of the present disclosure.

FIG. 4A is a block diagram depicting connections of the first layer L1 and the second layer L2 associated with switch SW0, according to some embodiments of the present disclosure.

Referring to FIG. 4A, and as similarly discussed above, the switch SW0 may provide connections between nodes N0 and N1, N4 and N5, N8 and N9, and Nc and Nd from each of the clusters C (e.g., the four clusters C), via the first layer L1. The switch SW0 may provide connections (e.g., one-hop inter-cluster connections) between corresponding nodes N of the clusters C1 and C2, via the second layer L2. For example, the second layer L2 connections provided by the switch SW0 may include connections between nodes NO and N4, nodes N1 and N5, nodes N2 and N6, and nodes N3 and N7.

FIG. 4B is a block diagram depicting connections of the first layer L1 and the second layer L2 associated with switch SW1, according to some embodiments of the present disclosure.

The switch SW1 may provide connections between nodes N0 and N2, N4 and N6, N8 and Na, and Nc and Ne from each of the clusters C (e.g., the four clusters C), via the first layer L1. The switch SW1 may provide connections (e.g., one-hop inter-cluster connections) between corresponding nodes N of the clusters C1 and C3, via the second layer L2. For example, the second layer L2 connections provided by the switch SW1 may include connections between nodes N0 and N8, nodes N1 and N9, nodes N2 and Na, and nodes N3 and Nb.

FIG. 4C is a block diagram depicting connections of the first layer L1 and the second layer L2 associated with switch SW2, according to some embodiments of the present disclosure.

The switch SW2 may provide connections between nodes N0 and N3, N4 and N7, N8 and Nb, and Nc and Nf from each of the clusters C (e.g., the four clusters C), via the first layer L1. The switch SW2 may provide connections (e.g., one-hop inter-cluster connections) between corresponding nodes N of the clusters C1 and C4, via the second layer L2. For example, the second layer L2 connections provided by the switch SW2 may include connections between nodes N0 and Nc, nodes N1 and Nd, nodes N2 and Ne, and nodes N3 and Nf.

FIG. 4D is a block diagram depicting connections of the first layer L1 and the second layer L2 associated with switch SW3, according to some embodiments of the present disclosure.

The switch SW3 may provide connections between nodes N1 and N3, N5 and N7, N9 and Nb, and Nd and Nf from each of the clusters C (e.g., the four clusters C), via the first layer L1. The switch SW3 may provide connections (e.g., one-hop inter-cluster connections) between corresponding nodes N of the clusters C2 and C4, via the second layer L2. For example, the second layer L2 connections provided by the switch SW3 may include connections between nodes N4 and Nc, nodes N5 and Nd, nodes N6 and Ne, and nodes N7 and Nf.

FIG. 4E is a block diagram depicting connections of the first layer L1 and the second layer L2 associated with switch SW4, according to some embodiments of the present disclosure.

The switch SW4 may provide connections between nodes N1 and N2, N5 and N6, N9 and Na, and Nd and Ne from each of the clusters C (e.g., the four clusters C), via the first layer L1. The switch SW4 may provide connections (e.g., one-hop inter-cluster connections) between corresponding nodes N of the clusters C2 and C3, via the second layer L2. For example, the second layer L2 connections provided by the switch SW4 may include connections between nodes N4 and N8, nodes N5 and N9, nodes N6 and Na, and nodes N7 and Nb.

FIG. 4F is a block diagram depicting connections of the first layer L1 and the second layer L2 associated with switch SW5, according to some embodiments of the present disclosure.

The switch SW5 may provide connections between nodes N2 and N3, N6 and N7, Na and Nb, and Ne and Nf from each of the clusters C (e.g., the four clusters C), via the first layer L1. The switch SW5 may provide connections (e.g., one-hop inter-cluster connections) between each of the nodes N of the clusters C3 and C4, via the second layer L2. For example, the second layer L2 connections provided by the switch SW5 may include connections between nodes N8 and Nc, nodes N9 and Nd, nodes Na and Ne, and nodes Nb and Nf.

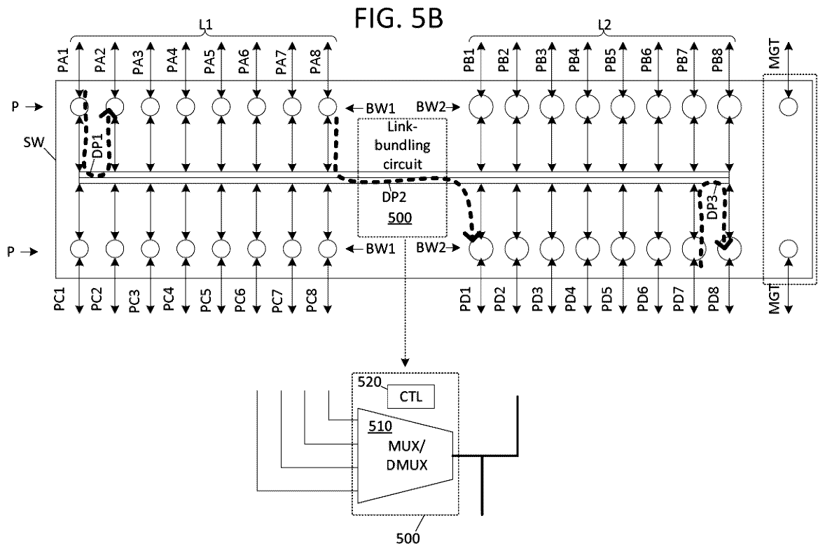

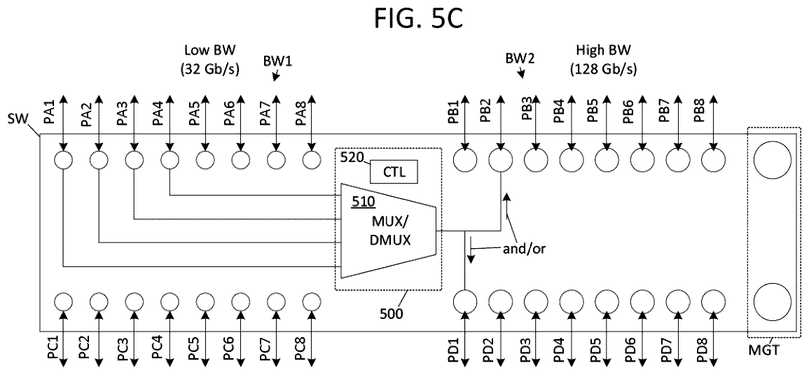

FIG. 5A is a diagram depicting potential data paths within a switch SW corresponding to one or more of the switches SW of the system 1 for network management, the switch SW having single bandwidth ports P, according to some embodiments of the present disclosure.

Referring to FIG. 5A, in some embodiments, the switches SW of the system 1 (see FIG. 1) may include two sets of ports P. For example, a first set of ports (e.g., ports PA1 through PA8) may be used to provide connections for the first layer L1. A second set of ports (e.g., ports PB1 through PB8) may be used to provide connections for the second layer L2. In some embodiments, the switches SW may include management ports MGT. For example, the management ports MGT may allow for in-band management and out-of-band management. In some embodiments, the switches SW may include ports P (e.g., eight ports P, including PA1 through PA8) for the first layer L1 and/or ports P (e.g., eight ports P, including PB1 through PB8) for the second layer L2. In some embodiments, each of the ports PA1 through PA8 may be associated with additional ports (e.g., PC1 through PC8), and/or each of the ports PB1 through PB8 may be associated with additional ports (e.g., PD1 through PD8). The additional ports PC1 through PC8 and PD1 through PD8 may allow for flexibility in providing connection paths for data. The ports P may provide connection paths for data, such as data path DP1, data path DP2, and data path DP3. For example, data path DP1 may correspond to the switch SW receiving data from a given node N connected to port PA1 and sending the data to a given node N connected to port PA2. Data path DP2 may correspond to the switch SW receiving data from a given node N connected to port PA8 and sending the data to a given node N connected to port PD1. Data path DP3 may correspond to the switch SW receiving data from a given node N connected to port PD7 and sending the data to a given node N connected to port PD8.

In some embodiments, the ports PA1 through PA8 and the ports PB1 through PB8 may be used for configuring a given number of Nodes N (e.g., a target number of noes N). For example, a number of target nodes N to interconnect may determine a number of ingress ports (e.g., the ports PA1 through PA8 and/or the ports PB1 through PB8) and may determine a number of egress ports (e.g., the ports PC1 through PC8 and/or the ports PD1 through PD8). In some embodiments, 16 target nodes may be connected with a given switch baseboard SBB utilizing 16 ports (e.g., the ports PA1 through PA8 and the ports PB1 through PB8) bi-directionally for the given switch baseboard SBB. In some embodiments, the ports PC1 through PC8 and/or the ports PD1 through PD8 may be utilized for a different purpose than the ports PA1 through PA8 and/or the ports PB1 through PB8. For example, in some embodiments, a greater number of target nodes N may be interconnected by connecting two given switch baseboards SBB back-to-back via the ports PC1 through PC8 and/or the ports PD1 through PD8. For example, 32 nodes N may be interconnected via two interconnected switch baseboards SBB. In some embodiments, the ports PC1 through PC8 and/or the ports PD1 through PD8 may be interconnected with other switch baseboards SBB according to a hyper-torus interconnection scheme for clustering nodes N at a switch-baseboard level.

In some embodiments, the ports P associated with the first layer L1 may have a first bandwidth BW1 that is the same as a first bandwidth BW1 of the ports P associated with the second layer L2. A switch SW having ports P with all the same bandwidth may be connected to the nodes N via single-bandwidth links. The size of the ports P of the switch SW of FIG. 5A are depicted as having the same size, which indicates that, in some embodiments, the ports P having a same depicted size may have a same bandwidth BW.

FIG. 5B is a diagram depicting potential data paths within a switch SW corresponding to one or more of the switches SW of the system 1 for network management, the switch SW having multi-bandwidth ports P, according to some embodiments of the present disclosure.

Referring to FIG. 5B, in some embodiments, the first bandwidth BW1 may be associated with the ports P of the first layer L1, and a second bandwidth BW2, which is different from the first bandwidth BW1, may be associated with the ports P of the second layer L2. Such embodiments may provide for improved bandwidth and reduced latency for the system 1. In such embodiments, the switch SW may include a link-bundling circuit 500. As discussed in further detail below with reference to FIG. 5C, the link-bundling circuit 500 may provide a data path between one or more ports P having the first bandwidth BW1 and one or more ports P having the second bandwidth BW2. The size of the ports P of the switch SW of FIG. 5B are depicted as having different sizes, which indicates that, in some embodiments, the ports P having different depicted sizes may have different bandwidths BW. For example, ports P depicted with a larger diameter may indicate that the ports P have a higher bandwidth BW (e.g., BW2) than ports P depicted with a smaller diameter to indicate a smaller bandwidth BW (e.g., BW1).

FIG. 5C is a diagram depicting an example of how the link-bundling circuit 500 of the switch SW of FIG. 5B may be configured for connecting multi-bandwidth ports, according to some embodiments of the present disclosure.

Referring to FIG. 5C, multiple ports P associated with a lower bandwidth (e.g., the first bandwidth BW1) may be bundled (e.g., multiplexed) by the link-bundling circuit 500 and sent to one or more ports P associated with a higher bandwidth (e.g., the second bandwidth BW2), to improve the bandwidth and/or to reduce the latency of the system 1. In some embodiments, the link-bundling circuit 500 may include a multiplexer/demultiplexer (MUX/DMUX) circuit 510. For example, the MUX/DMUX circuit 510 may include a multiplexer and/or a demultiplexer. In some embodiments, the link-bundling circuit 500 may include a controller 520 (e.g., control logic). In some embodiments, one or more ports P associated with the higher bandwidth may be split (e.g., demultiplexed) by the link-bundling circuit 500 and sent to one or more ports P associated with the lower bandwidth. For example, the first bandwidth BW1 may be equal to about 32 gigabits per second (Gb/s), and the second bandwidth BW2 may be equal to about 128 Gb/s. In such a case, ports P (e.g., four ports P) associated with the first bandwidth BW1 (e.g., ports PA1 through PA4) may be provided to the link-bundling circuit 500, and the link-bundling circuit 500 may send a bundled output signal to one or more of the ports P having a higher bandwidth (e.g., port PB2 and/or port PD1). In some embodiments, the bundling provided by the link-bundling circuit may be associated with a given protocol (e.g., CXL or PCIe).

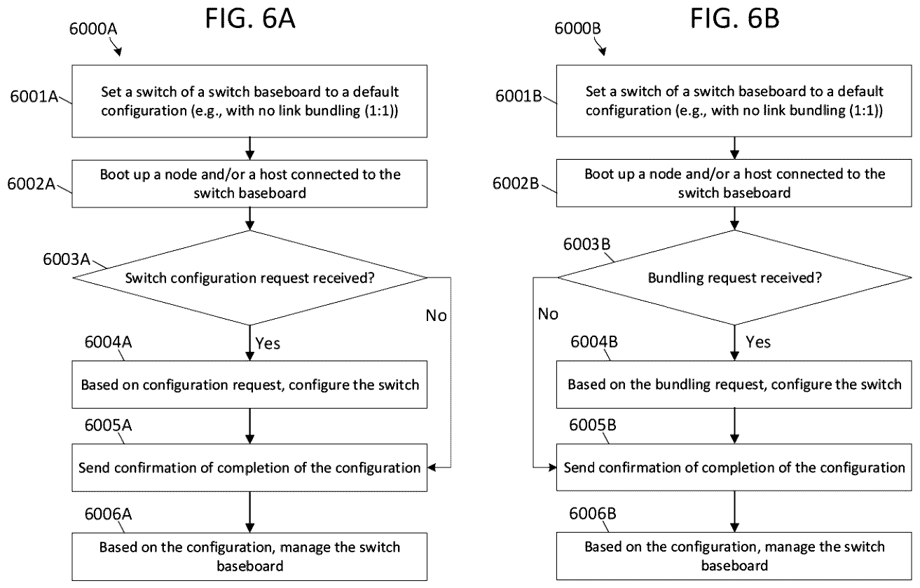

FIG. 6A is a flowchart depicting operations of a method for network management using the switch SW of FIG. 5A or FIG. 5B, according to some embodiments of the present disclosure.

Referring to FIG. 6A, the method 6000A may include the following example operations. A switch baseboard SBB (or logic associated with the switch baseboard SBB) may cause a switch SW to be set to a configuration (e.g., a default configuration, such as no link bundling, with 1-to-1 pairing of input ports P and output ports P) (operation 6001A). A node N or a host 100 may be booted up (e.g., activated or connected to the switch baseboard SBB) (operation 6002A). The switch baseboard SBB (or logic associated with the switch baseboard SBB) may determine whether a switch configuration request has been received by the switch baseboard SBB (or logic associated with the switch baseboard SBB) (operation 6003A). If no switch configuration request has been received, the switch baseboard SBB (or logic associated with the switch baseboard SBB) may send confirmation (e.g., to a given host 100 or a given node N) of completion of the configuration (operation 6005A). If yes, then based on the configuration request, the switch baseboard SBB (or logic associated with the switch baseboard SBB) may configure the switch SW (operation 6004A). After the switch SW is configured, the switch baseboard SBB (or logic associated with the switch baseboard SBB) may send confirmation (e.g., to a given host 100 or a given node N) of completion of the configuration (operation 6005A). Based on the configuration, the system 1 may manage the switch baseboard SBB (e.g., send and/or receive data based on the configuration) (operation 6006A).

FIG. 6B is a flowchart depicting operations of a method for network management using the switch SW of FIG. 5B and the switch SW of FIG. 5C, according to some embodiments of the present disclosure.

Referring to FIG. 6B, the method 6000B may include the following example operations. A switch baseboard SBB (or logic associated with the switch baseboard SBB) may cause a switch SW to be set to a configuration (e.g., a default configuration, such as no link bundling, with 1-to-1 pairing of input ports P and output ports P) (operation 6001B). A node N or a host 100 may be booted up (e.g., activated or connected to the switch baseboard SBB) (operation 6002B). The switch baseboard SBB (or logic associated with the switch baseboard SBB) may determine whether a bundling request has been received by the switch baseboard SBB (or logic associated with the switch baseboard SBB) (operation 6003B). If no bundling request has been received, the switch baseboard SBB (or logic associated with the switch baseboard SBB) may send confirmation (e.g., to a given host 100 or a given node N) of completion of the configuration (operation 6005B). If yes, then based on the bundling request, the switch baseboard SBB (or logic associated with the switch baseboard SBB) may configure the switch SW (operation 6004B). After the switch SW is configured, the switch baseboard SBB (or logic associated with the switch baseboard SBB) may send confirmation (e.g., to a given host 100 or a given node N) of completion of the configuration (operation 6005B). Based on the configuration, the system 1 may manage the switch baseboard SBB (e.g., send and/or receive data based on the configuration) (operation 6006B).

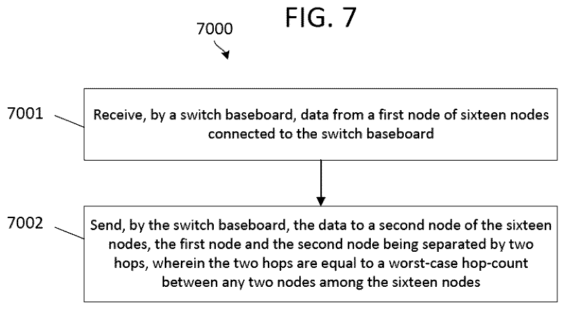

FIG. 7 is a flowchart depicting operations of a method for network management, including sending data from one node N to another node N, according to some embodiments of the present disclosure.

Referring to FIG. 7, the method 7000 may include the following example operations. A switch baseboard SBB may receive data from a first node N (e.g., node NO) of a set of nodes (e.g., sixteen nodes, including nodes N0 through Nf) (operation 7001). The switch baseboard SBB may send the data to a second node (e.g., node Na) (see FIG. 3B) of the nodes (e.g., the sixteen nodes, including nodes N0 through Nf) (operation 7002). The first node and the second node may be separated by two hops (e.g., the first hop h1 and the second hop h2). Two hops may be equal to a worst-case hop count between any two nodes among the nodes (e.g., the sixteen nodes, including nodes N0 through Nf).

Accordingly, aspects of some embodiments of the present disclosure may provide improvements to memory management by reducing hop counts and, thereby, latencies between nodes N within node grouping (e.g., a sixteen node grouping) of nodes N. Additionally, the modular characteristics of the switch baseboards SBB may allow for efficient scaling for resource pooling.

Example embodiments of the disclosure may extend to the following statements, without limitation:

Statement 1. An example method includes: receiving, by a switch baseboard, data from a first node of a set of nodes connected to the switch baseboard, and sending, by the switch baseboard, the data to a second node of the set of nodes, the first node and the second node being separated by two hops, wherein the switch baseboard, includes switches to interconnect the nodes of the set of nodes via a first layer connecting a first cluster of nodes of the set of nodes into full-mesh-connected nodes including the first node as the first node of the first cluster, a second cluster of nodes of the set of nodes into full-mesh-connected nodes, a third cluster of nodes of the set of nodes into full-mesh-connected nodes including the second node as a second node of the third cluster, and a fourth cluster of nodes of the set of nodes into full-mesh-connected nodes, and a second layer including inter-cluster connections to connect the first node of the first cluster to a first node of the third cluster by one hop, the first node of the third cluster being connected to the second node of the third cluster by one hop.

Statement 2. An example method includes the method of statement 1, wherein the second layer further includes inter-cluster connections to connect the first node of the first cluster to a first node of the second cluster by one hop, and a first node of the fourth cluster by one hop.

Statement 3. An example method includes the method of any of statements 1 and 2, wherein the switches include a first switch including a first set of ports associated with the first layer, and a second set of ports associated with the second layer.

Statement 4. An example method includes the method of statement 3, wherein the first set of ports are associated with a first bandwidth that is different from a second bandwidth associated with the second set of ports.

Statement 5. An example method includes the method of any of statements 1-4, wherein the second layer further includes inter-cluster connections to connect the second node of the third cluster to a second node of the fourth cluster by one hop.

Statement 6. An example method includes the method of any of statements 1-5, wherein the nodes of the set of nodes include memory and are interconnected to form a memory pool.

Statement 7. An example method includes the method of any of statements 1-6, wherein the switch baseboard is configured to support a cache-coherent protocol.

Statement 8. An example method includes the method of any of statements 1-7, wherein the switch baseboard is a first switch baseboard of n switch baseboards of a system, n being an integer greater than one, and the n switch baseboards support 16×n nodes.

Statement 9. An example system for performing the method of any of statements 1-8 includes the set of nodes connected to the switch baseboard, and the switches to interconnect the nodes of the set of nodes via the first layer and via the second layer.

While embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A system for network management, the system comprising:
a switch baseboard comprising switches to interconnect nodes via:
a first layer connecting:
a first cluster of the nodes into full-mesh-connected nodes;
a second cluster of the nodes into full-mesh-connected nodes;
a third cluster of the nodes into full-mesh-connected nodes; and
a fourth cluster of the nodes into full-mesh-connected nodes; and
a second layer comprising inter-cluster connections to connect a first node of the first cluster to:
a first node of the second cluster by one hop; and
a first node of the third cluster by one hop.

2. The system of claim 1, wherein the switches comprise a first switch comprising:
a first set of ports associated with the first layer; and
a second set of ports associated with the second layer.

3. The system of claim 2, wherein the first set of ports are associated with a first bandwidth that is different from a second bandwidth associated with the second set of ports.

4. The system of claim 1, wherein the second layer further comprises inter-cluster connections to connect the first node of the first cluster to a first node of the fourth cluster by one hop.

5. The system of claim 4, wherein the second layer further comprises inter-cluster connections to connect:
a second node of the first cluster to:
a second node of the second cluster by one hop;
a second node of the third cluster by one hop; and
a second node of the fourth cluster by one hop; and
a third node of the first cluster to:
a third node of the second cluster by one hop;
a third node of the third cluster by one hop; and
a third node of the fourth cluster by one hop; and
a fourth node of the first cluster to:
a fourth node of the second cluster by one hop;
a fourth node of the third cluster by one hop; and
a fourth node of the fourth cluster by one hop.

6. The system of claim 1, wherein:
the first layer comprises a first port having a first bandwidth;
the second layer comprises a second port having a second bandwidth; and
the second bandwidth is greater than the first bandwidth.

7. The system of claim 6, wherein:
the first layer comprises a third port having a third bandwidth that is less than the second bandwidth;
the first port is configured to send a first signal to a bundling-circuit;
the third port is configured to send a second signal to the bundling-circuit; and
an output of the bundling-circuit is connected to the second port.

8. The system of claim 1, wherein the inter-cluster connections form hyper-torus connections between the nodes.

9. The system of claim 1, wherein the nodes comprise memory and are interconnected to form a memory pool.

10. The system of claim 1, wherein the switch baseboard is configured to support a cache-coherent protocol.

11. The system of claim 1, wherein:
the switch baseboard is a first switch baseboard of n switch baseboards of the system, n being an integer greater than one; and
the n switch baseboards support 16×n nodes.

12. A method for network management, the method comprising:
receiving, by a switch baseboard, data from a first node of a set of nodes connected to the switch baseboard; and
sending, by the switch baseboard, the data to a second node of the set of nodes, the first node and the second node being separated by two hops,
wherein the switch baseboard, comprises switches to interconnect the nodes of the set of nodes via:
a first layer connecting:
a first cluster of nodes of the set of nodes into full-mesh-connected nodes comprising the first node as the first node of the first cluster;
a second cluster of nodes of the set of nodes into full-mesh-connected nodes;
a third cluster of nodes of the set of nodes into full-mesh-connected nodes comprising the second node as a second node of the third cluster; and
a fourth cluster of nodes of the set of nodes into full-mesh-connected nodes; and
a second layer comprising inter-cluster connections to connect the first node of the first cluster to a first node of the third cluster by one hop, the first node of the third cluster being connected to the second node of the third cluster by one hop.

13. The method of claim 12, wherein the second layer further comprises inter-cluster connections to connect the first node of the first cluster to:
a first node of the second cluster by one hop; and
a first node of the fourth cluster by one hop.

14. The method of claim 13, wherein the switches comprise a first switch comprising:
a first set of ports associated with the first layer; and
a second set of ports associated with the second layer.

15. The method of claim 14, wherein the first set of ports are associated with a first bandwidth that is different from a second bandwidth associated with the second set of ports.

16. The method of claim 13, wherein the second layer further comprises inter-cluster connections to connect the second node of the third cluster to a second node of the fourth cluster by one hop.

17. The method of claim 13, wherein the nodes of the set of nodes comprise memory and are interconnected to form a memory pool.

18. The method of claim 13, wherein the switch baseboard is configured to support a cache-coherent protocol.

19. The method of claim 13, wherein:
the switch baseboard is a first switch baseboard of n switch baseboards of a system, n being an integer greater than one; and
the n switch baseboards support 16×n nodes.

20. A system for network management, the system comprising:
a switch baseboard comprising switches to interconnect nodes via:
a first layer connecting:
a first cluster of the nodes into full-mesh-connected nodes;
a second cluster of the nodes into full-mesh-connected nodes; and
a third cluster of the nodes into full-mesh-connected nodes; and
a second layer comprising inter-cluster connections to connect a first node of the first cluster to:
a first node of the second cluster by one hop; and
a first node of the third cluster by one hop,
wherein the switch baseboard is configured to:
receive data from a first node of the nodes; and
send the data to a second node of the nodes, the first node and the second node being separated by two hops.
